(19) United States
(12) Patent Application Publication
(10) Pub. No.: US 2023/0103750 A1
(43) Pub. Date: Apr. 6, 2023

(54) BALANCING WORKLOAD FOR ZERO SKIPPING ON DEEP LEARNING ACCELERATOR

(71) Applicant: MEDIATEK INC., Hsinchu (TW)

(72) Inventors: Wei-Ting WANG, Hsinchu (TW); Jeng-Yun HSU, Hsinchu (TW); Shao-Yu WANG, Hsinchu (TW); Han-Lin LI, Hsinchu (TW)

(73) Assignee: MEDIATEK INC., Hsinchu (TW)

(21) Appl. No.: 17/495,436

(22) Filed: Oct. 6, 2021

(51) Int. Cl. G06N 3/02

(52) U.S. Cl. CPC G06N 3/02

(57) ABSTRACT

A method of balancing workloads among processing elements (PEs) in a neural network processor can include receiving first weights and second weights of a neural network. The first and second weights are associated with a first and a second output channel (OC), respectively. A first PE computes a partial sum (PSUM) of an output activation of the first OC based on the non-zero weights in the first weights. A second PE computes a PSUM of an output activation of the second OC based on the non-zero weights in the second weights. A controller can allocate one or more non-zero weights of the first weights to the second PE for computing the PSUM of the output activation of the first OC to balance a workload.

### TECHNICAL FIELD

The present disclosure relates to efficient processing of artificial neural networks, and more specifically, relates to load-balanced execution and hardware-aware pruning of deep neural networks (DNNs).

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

A deep learning accelerator (DLA) as customized hardware can be used to accelerate the processing of deep neural networks (DNNs). For example, a pruning process can be performed to sparsify a neural network model. The DLA can include logic to identify zero and non-zero elements in the sparse neural network model. Zero elements are skipped while non-zero elements are dispatched to processing elements (PEs) for execution. Such zero-skipping operations can increase the speed as well as the power efficiency for processing a DNN.

### SUMMARY

Aspects of the disclosure provide a method of balancing workloads among processing elements (PEs) in a neural network processor. The method can include receiving, at a memory in a neural network processor, first weights and second weights of a convolutional layer of a neural network, the first weights associated with a first output channel (OC) of the convolutional layer, the second weights associated with a second OC of the convolutional layer, computing, by a first PE in the neural network processor, a partial sum (PSUM) of an output activation of the first OC based on the non-zero weights in the first weights, computing, by a second PE in the neural network processor, a PSUM of an output activation of the second OC based on the non-zero weights in the second weights, and allocating, by a controller in the neural network processor, one or more non-zero weights of the first weights to the second PE for computing the PSUM of the output activation of the first OC to balance a workload between the first PE and the second PE when a first number of the non-zero weights in the first weights is larger than a second number of the non-zero weights in the second weights.

In an embodiment, the first weights and the second weights correspond to a same set of input channels (ICs) of the convolutional layer. In an embodiment, the method further includes determining, by the controller in the neural network processor, whether a workload imbalance exists between the first PE and the second PE based on the first number of the non-zero weights in the first weights and the second number of the non-zero weights in the second weights.

In an embodiment, the first weights and the second weights are in a compressed form. In an embodiment, a workload of every two sets of weights in the memory corresponding to every two neighboring active OCs in a sequence of OCs of the convolutional layer is balanced by the controller in the neural network processor between a pair of PEs in the neural network processor according to an amount of non-zero weights in each set of the weights. In an embodiment, the first OC and the second OC are not adjacent to each other in a sequence of OCs of the convolutional layer.

In an embodiment, the method can further include ranking, by the controller in the neural network processor, N sets of weights in the memory according to a sparsity of each of the N sets of the weights, each set of the N sets of the weights corresponding to an active OC in a sequence of OCs of the convolutional layer and having an index of i after the ranking, the index i being in a range from 0 to N−1. A workload of every two sets of weights in the memory having indexes of i and N−1−i for i in a range from 0 to (N/2)−1 is balanced by the controller in the neural network processor according to an amount of the non-zero weights in each of the N sets of the weights in the memory.

In an embodiment, among N sets of weights in the memory, each set of the N sets of the weights corresponding to an active OC in a sequence of OCs of the convolutional layer. A first workload of the set of the weights with a maximum amount of non-zero weights and the set of the weights with a minimum amount of non-zero weights is balanced by the controller in the neural network processor between a first pair of PEs, and a second workload of the set of the weights with a second maximum amount of non-zero weights and the set of the weights with a second minimum amount of non-zero weights is balanced by the controller in the neural network processor between a second pair of PEs.

In an embodiment, the method can further include ranking, by a compiler, M sets of weights according to a sparsity of each set of the weights, each set of the M sets of the weights corresponding to an OC in a sequence of OCs of the convolutional layer, and reordering, by the compiler, the OCs corresponding to the M sets of the weights according to respective ranks of the M sets of the weights, the first weights and the second weights being two sets of weights among the M sets of weights.

In an embodiment, the method can further include reordering, by a compiler, a sequence of OCs of the convolutional layer according to a sparsity of a set of weights corresponding to each OC such that the OC of the set of the weights with a highest sparsity and the OC of the set of the weights with a lowest sparsity are adjacent with each other. In an embodiment, the method can further include balancing a workload of P sets of weights corresponding to P number of OCs of the convolutional layer in the neural network among P number of PEs, P being a number larger than 2.

In an embodiment, zero-weights among the first weights and the second weights are skipped for processing during the computing by the first PE and the second PE.

Aspects of the disclosure provide another method of workload balancing for neural network processing. The method can include receiving N sets of weights of a convolutional layer of a neural network, each set of the N sets of the weights corresponding to an output channel (OC) in a sequence of OCs of the convolutional layer, ranking the N sets of weights according to a workload of each of the N sets of the weights, the workload of each of the N sets of the weights indicated by an amount of the non-zero weights in each of the N sets of the weights, a rank of each of the N sets of weights after the ranking being indicated by an index of i, the index i being in a rage from 0 to N−1, and combining the workloads of the two sets of weights corresponding to the indexes of i and N−1−i into a combined workload for at least one index i in a range from 0 to (N/2)−1, the combined workloads each being mapped to a group of one or more processing element (PEs).

In an example, the workload of the set of the weights with a maximum amount of non-zero weights and the workload of the set of the weights with a minimum amount of non-zero weights are combined and mapped to the respective group of one or more PEs. The workload of the set of the weights with a second maximum amount of non-zero weights and the workload of the set of the weights with a second minimum amount of non-zero weights are combined and mapped to the respective group of one or more PEs.

In an example, the OCs corresponding to the N sets of the weights can be reordered according to the respective ranks of the N sets of the weights. In various embodiments, the ranking or reordering can be performed by a compiler or a neural network processor.

While workloads corresponding to two OCs (adjacent or non-adjacent) are assumed to be performed by a pair of PEs in some examples described herein, workloads of a group of OCs (2, 3, or more) identified by various ways (being adjacent OCs, ranking, and/or reordering, or the like) can readily be mapped, scheduled, or assigned to any number of PEs in place of the pair of PEs. For example, workloads of two identified OCs can be combined and assigned to one PE or 3 PEs for processing. No matter what number of PEs in a group of PEs are allocated for processing a combined workload, the load balancing performance can be achieved among different groups of PEs by suitably employing the load balancing techniques disclosed herein.

Aspects of the disclosure further provide a method of pruning weights in a convolutional layer of a neural network. The method can include receiving N sets of weights of a convolutional layer of a neural network, each set of the weights having a same number of weights and corresponding to one of a sequence of OCs of the convolutional layer, and performing a pruning process to prune M sets of the weights among the N sets of the weights such that each of the M sets of the weights has a same number of non-zero weights, M being smaller than or equal to N, M being equal to a number of active OCs to be processed in parallel in a neural network processor.

In an embodiment, the pruning process is performed by a compiler or the neural network processor. In an embodiment, the pruning process includes determining K weights from each of L sets of the weights among the N sets of the weights, L being in a range of 2 to N, the K weights of each of the L sets of the weights corresponding to a same set of active ICs to be processed in the neural network processor, and pruning the K weights of each of the L sets of the weights such that the K weights of each of the L sets of the weights have a same number of non-zero weights. In an example, L is equal to the number of active OCs to be processed in parallel in the neural network processor and is equal to or smaller than M.

In an embodiment, the pruning process includes partitioning the weights in each of L sets of the weights among the N sets of the weights into groups of weights, the groups in each of the L sets of the weights having indexes from 0 to i, L being in a range of 2 to N, the groups of weights with the same index in different sets of the L sets of the weights corresponding to a same set of active ICs to be processed in the neural network processor, ranking the weights in each group of weights in the L sets of weights according to weight magnitudes, and pruning the weights from each group of weights in the L sets of weights according to ranks of the respective weights, a same number of weights being pruned for the groups of weights with the same index in each of the L sets of weights.

Aspects of the disclosure further provide a method of IC-based workload partitioning and balancing. The method can include receiving weight kernels corresponding to an OC in a convolutional layer of a neural network, each weight kernel corresponding to an IC in the convolutional layer of the neural network, partitioning the weight kernels into K groups of weight kernels according to a number of non-zero weights in each of the weight kernels such that a workload of the received weight kernels is balanced among the K groups of weight kernels, K being a number of processing cores in a neural network processor used for computing output activations for the OC in the convolutional layer of the neural network, and assigning the K groups of weight kernels to the K processing cores, respectively, for computing in parallel the output activations for the OC in the convolutional layer of the neural network.

In an embodiment, the convolutional layer of the neural network includes N number of OCs, and weight kernels of each of the N number of OCs are petitioned into K groups according to an amount of non-zero weights in the respective weight kernels for workload balancing among the respective K groups. In an embodiment, the partitioning of the weight kernels and the assigning of the K groups of weight kernels are performed by a compiler or a controller in the neural network processor.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an example of a convolutional layer 100 in a neural network and related convolution operations according to embodiments of the disclosure.

FIG. 2 shows an example of zero-skipping operations in an output activation computation process 200 according to embodiments of the disclosure.

FIG. 3 shows a convolution computation process 300.

FIG. 4A shows an example of workload imbalance among 4 PEs due to PE zero-skipping.

FIG. 4B shows another example of workload imbalance among PEs due to PE zero-skipping performance.

FIG. 5A shows an example of unbalanced workloads between OCs. As shown, there are 12 ICs and 2 OCs.

FIG. 5B shows another example of unbalanced workloads between OCs, however, considering a size of an IC buffer.

FIG. 6A shows a workload balancing (sharing) scheme 600A according to an embodiment of the disclosure.

FIG. 6B shows another workload balancing (sharing) scheme 600B according to an embodiment of the disclosure.

FIGS. 7A-7B show a technique of reordering back OCs when the OC reordering and paired-PE sharing scheme are employed.

FIG. 8A shows a pruning scheme 800A according to an embodiment of the disclosure.

FIG. 8B shows another pruning scheme 800B according to an embodiment of the disclosure.

FIG. 9 shows a workload allocation method 900, referred to as symmetric multi-core IC slicing.

FIG. 10 shows another workload allocation method 1000, referred to as dynamic asymmetric multi-core IC slicing.

FIG. 11 shows a neural network processor 1100 according to an embodiment of the disclosure.

FIG. 12 shows another neural network processor 1200 according to an embodiment of the disclosure.

FIG. 13 shows a process 1300 of balancing workloads among PEs in a neural network processor according to an embodiment of the disclosure.

FIG. 14 shows a process 1400 of pruning weights in a convolutional layer of a neural network.

FIG. 15 shows a process 1500 of IC-based workload partitioning and balancing according to an embodiment of the disclosure.

FIG. 16 shows a process 1600 of balancing workloads among different PEs or PE groups according to an embodiment of the disclosure.

FIG. 17 shows an exemplary apparatus 1700 according to embodiments of the disclosure.

### DETAILED DESCRIPTION OF EMBODIMENTS

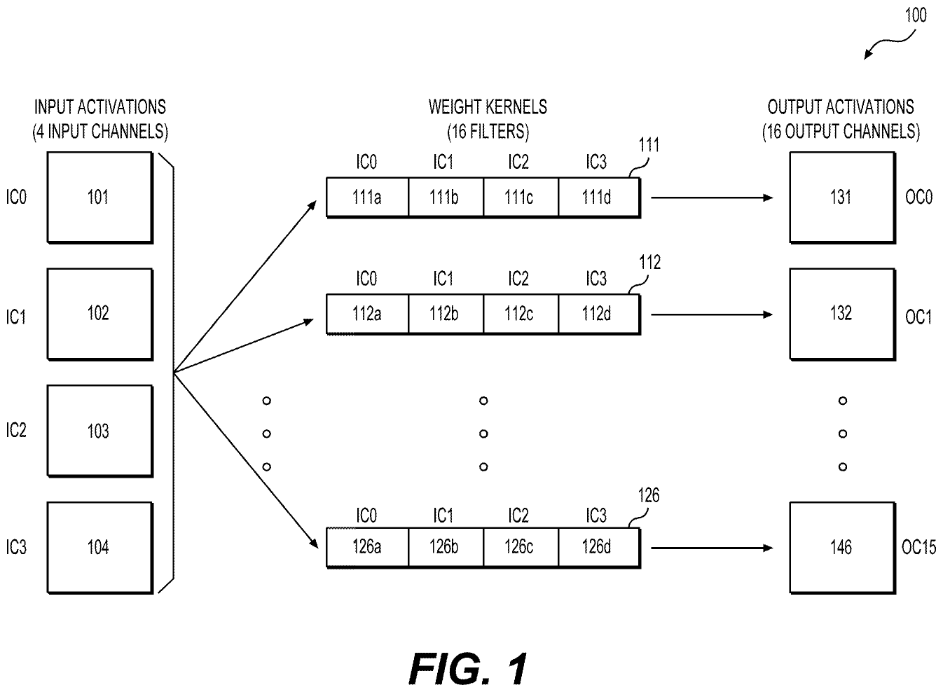

FIG. 1 shows an example of a convolutional layer 100 in a neural network and related convolution operations according to embodiments of the disclosure. The convolutional layer 100 can include 4 input channels (ICs) 101-104, 16 filters 111-126, and 16 output channels (OCs) 131-146. The ICs 101-104 (denoted 1C0-1C3) can each include an array of input activations, for example, generated from a previous layer in the neural network. The filters 111-126 can each include 4 weight kernels corresponding to the 4 ICs 101-104, respectively. As shown, the filter 111 includes the weight kernels 111a-111d; the filter 1 12 includes the weight kernels 112a-112d; and the filter 126 includes the weight kernels 126a-126d. Each weight kernel in the filters 111-126 can include an array of weights (weight coefficients), such as 1×1 weight, 2×2 weights, 3×3 weights, and the like.

The OCs 131-146 can each include an array of output activations generated from respective convolution operations. For example, assuming a kernel size of 3×3 weights, by a convolution operation between the 36 weights in the filter 111 and the corresponding 36 input activations in the ICs 101-104, an output activation in the OC 131 can be generated.

In various examples, a convolutional layer can include different numbers of ICs or OCs than the FIG. 1 example. The convolutional layer can include the same number of filters as the number of the OCs. The filters can each include the same number of weight kernels as the number of the ICs.

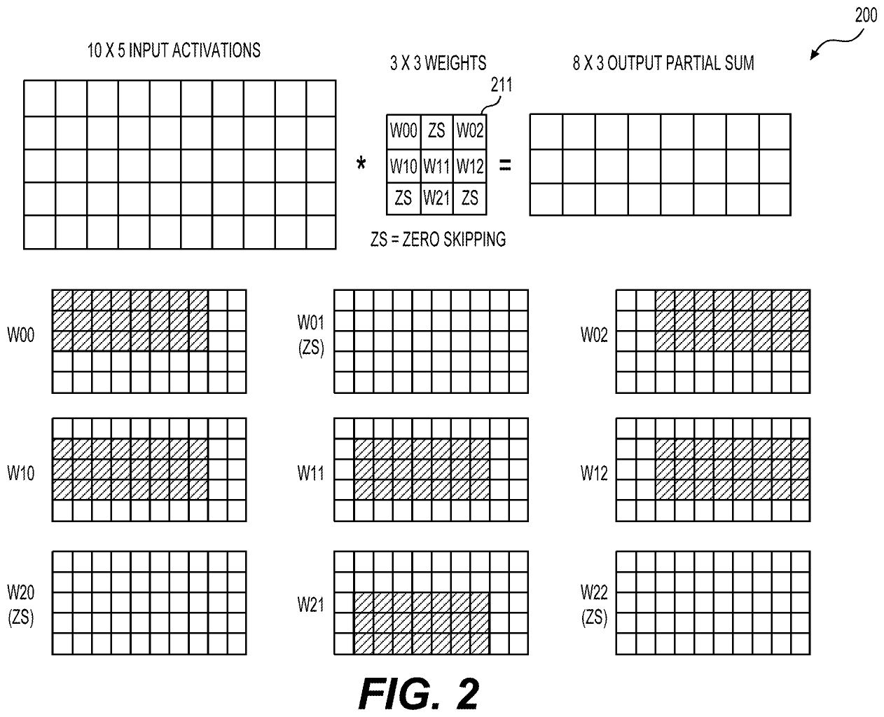

FIG. 2 shows an example of zero-skipping operations in an output activation computation process 200 according to embodiments of the disclosure. As shown, 8∴3 output activations (partial sums(PSUMs)) are computed with 10×5 activations and a weight kernel 211 as input. The weight kernel 211 can include 3×3 weights denoted by W00, W01, W03, . . . , and W22. Particularly, the weights W01, W20, and W22 are zero weights, while the other weights are non-zero weights in the weight kernel 211.

During the computation process 200, the zero weights can be skipped. For example, for each non-zero weight W00, W02, W10, W11, W12, and W21, a processing element (PE) can receive 8×3 input activations selected from the 10×5 input activations (shaded areas in the respective 10×5 input activations in the lower part of FIG. 2), and multiply the input activations with the respective weight to generate 8×3 output PSUMs. The 8×3 PSUMs corresponding to different weights can be accumulated to generate accumulated 8×3 PSUMs. For each zero weight (e.g., W01, W10, and W22), the PE can identify the zero weight, and effectively skip any computation to reduce a workload of the PE.

In the output activation computation process 200, 6 multiply-and-accumulate (MAC) operations are performed for each of the 8×3 output PSUMs, which corresponds to the 6 non-zero weights, while 3 MAC operations are skipped due to the 3 zero-valued weights. As can be seen, the number of non-zero weights (or zero-weights) in weight kernels can determine the workload for computing output activations of an IC in a convolutional layer when zero-skipping techniques are employed.

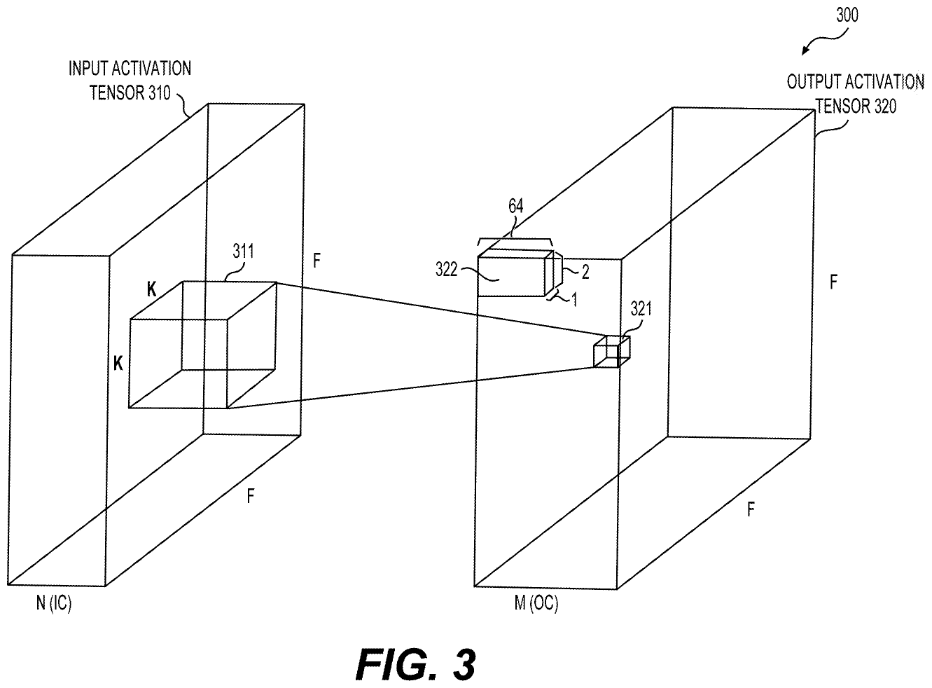

FIG. 3 shows a convolution computation process 300. As shown, an input activation tensor 310 input to the process 300 has a size of F×F×N. N can be a number of ICs. An output activation tensor 320 resulting from the process 300 has a size of F×F×M in this particular example. M can be a number of OCs. Each activation 321 can be computed based on an array of input activations 311 of a size of K×K×N. K can be a kernel size.

During the process 300, the M OCs (M number of OCs) can be partitioned into several portions. Each portion includes a subset of M OCs. The portions can be computed one by one to match memory and computation restrictions (e.g., on-chip buffer size and number of PEs) of a deep learning accelerator (DLA). The OCs with the activations under processing in a DLA are referred to as active OCs. Corresponding to the active OCs, a corresponding number of filters can be loaded to the DLA (stored in on-chip memory) instead of all the filters corresponding to all M OCs. Those loaded filters can be referred to as active filters.

It is noted that, although the DLA is used as an example to explain various workload balancing techniques in some examples, the workload balancing techniques disclosed herein are not limited to DLAs. For example, the workload balancing techniques can be used in or implemented with a central processing unit (CPU), a graphics processing unit (GPU), field-programmable gate arrays (FPGA), an application-specific integrated circuit (ASIC), and the like.

Similarly, during the process 400, the N ICs can be loaded to the DLA portion by portion to match the memory and computation restrictions of the DLA. Thus, the ICs under processing can be referred to as active ICs. Corresponding to the active ICs, the corresponding weight kernels in the active filters can be loaded to the DLA instead of all N weight kernels.

Further, input activations of active ICs can be partitioned into 3D slices which are loaded to the DLA and processed one by one. An active 3D slice (currently under processing) of input activations can have a size of H0×W0×N0, for example. Corresponding to an active slice of input activations, an active slice of output activations (PSUMs) can be generated and have a size of H1×W1×M1, for example.

In various examples, input activations of input channels can be partitioned flexibly to match configurations of a DLA. Accordingly, suitable input activations and kernel weights can be scheduled and loaded to on-chip memories for computing output activations (PSUMs).

In an example, a DLA is configured with 128 PEs. Each PE is configured for computing one activation (or corresponding PSUM). A workload of computing an output activation is assigned to an individual PE. Accordingly, the number of non-zero weights in the respective weight kernels for computing the output activation determines the workload of this PE. In addition, 2 PEs are assigned for carrying the workload of 1 OC.

FIG. 3 shows a shape of an active slice 322 including 128 output activations generated by the 128 PEs. Corresponding to the active slice 322, the number of active OCs is 64; a height of the active slice 322 is 2 activations; and a width of the active slice 322 is 1 activation.

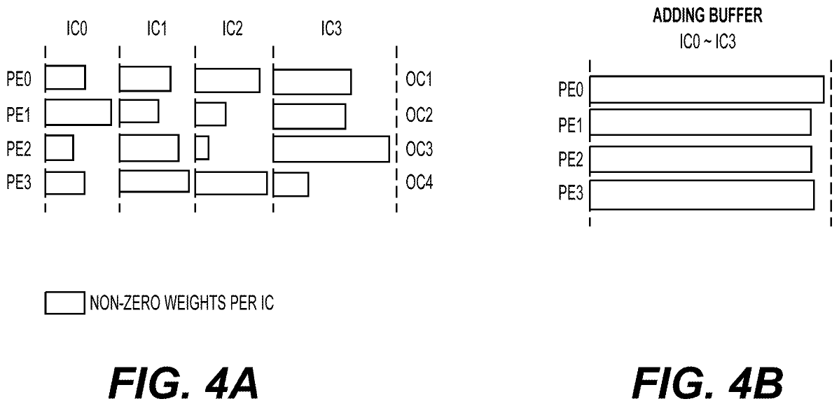

FIG. 4A shows an example of workload imbalance among 4 PEs due to PE zero-skipping. The 4 PEs (PE0-PE3) in a DLA are configured to compute activations corresponding to 4 OCs (OC0-OC1), respectively. In addition, due to an IC buffer configuration of the DLA, one IC of input activations can be buffered in an on-chip memory each time. Input activations of the ICs are loaded to the DLA sequentially (IC by IC) for processing. Accordingly, corresponding to each IC being processed, a respective weight kernel can be processed by each respective PE. Numbers of non-zero weights per IC and per PE (also per kernel) are represented by the columns in FIG. 4A. As the non-zero weights determine workloads, those columns thus can represent a workload per IC and per PE.

As shown, due to unbalanced distribution of zero weights among the PEs corresponding to each IC under processing, processing workloads are unbalanced among the PEs for each IC. For each IC from IC0 to IC3, a maximum processing time is determined by the maximum number of non-zero weights of either one of PE0-PE3. The total processing time is a sum of the maximum processing time of each IC (from IC0 to IC3).

FIG. 4B shows another example of workload imbalance among PEs due to PE zero-skipping performance. The same 4 PEs (PE0-PE3) as in FIG. 4A are shown in FIG. 4B. However, a larger on-chip buffer is provided to store the input activations of the 4 ICs shown in FIG. 4A. Due to the increased buffer size, the workloads unbalanced in IC granularity can be evened. The processing time for all 4 buffer ICs is determined by the maximum number of non-zero weights of the 4 ICs for each PE. The processing time can accordingly be reduced.

The solution of adding buffer to reduce workload imbalance has its limitations when considering cost restriction related with on-chip memory areas. Also, as shown in FIG. 4B, workload imbalance between PEs can still exist with an increased buffer size.

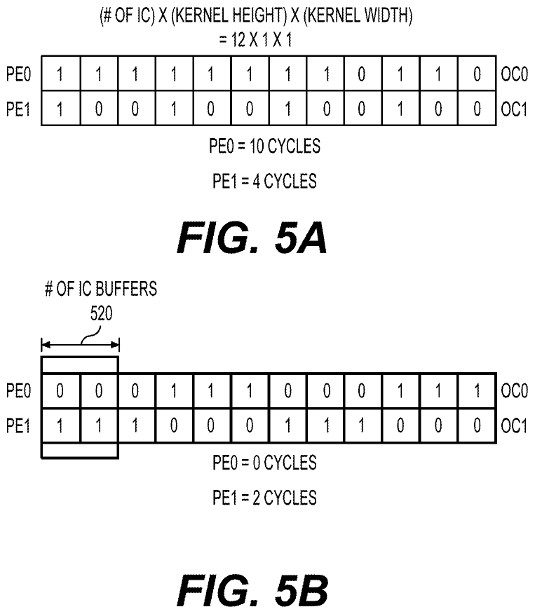

FIG. 5A shows an example of unbalanced workloads between OCs. As shown, there are 12 ICs and 2 OCs. For each OC, there are 12 weight kernels each having a kernel size of 1×1. Accordingly, there are 12 weights corresponding to each OC. Due to zero skipping, the workload for OC0 is 10 weights and can be performed using 10 cycles, while the workload for OC1 is 4 weights and can be performed using 4 cycles.

FIG. 5B shows another example of unbalanced workloads between OCs, however, considering a size of an IC buffer. In the FIG. 5B example, 12 kernel weights of each of OC0 and OC1 have the same number of 6 non-zero weights. The non-zero weights are balanced between OC0 and OC1. The IC buffer has a size 520 of two and can store input activations of two ICs. Accordingly, two ICs are active at a given time, and two corresponding weight kernels (2 weights in FIG. 5B) can be active and under processing. Considering the workloads of non-zero weights in the IC buffer, a workload of PE0 is zero, while a workload of PE1 is 2. Thus, a workload imbalance exists between weights of different OCs given an IC buffer size even though zero weights of all weight kernels corresponding to each of OC0 and OC1 are balanced.

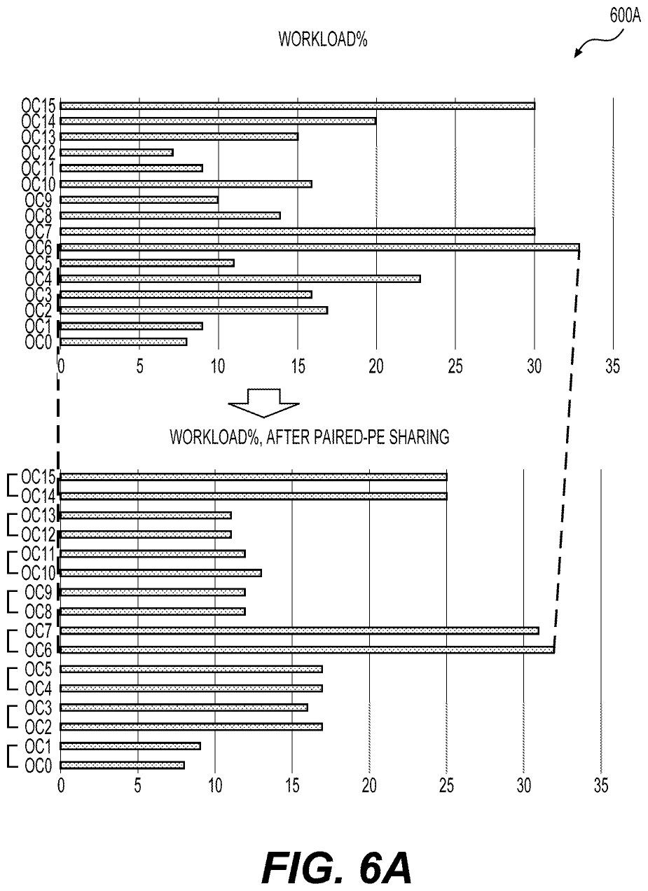

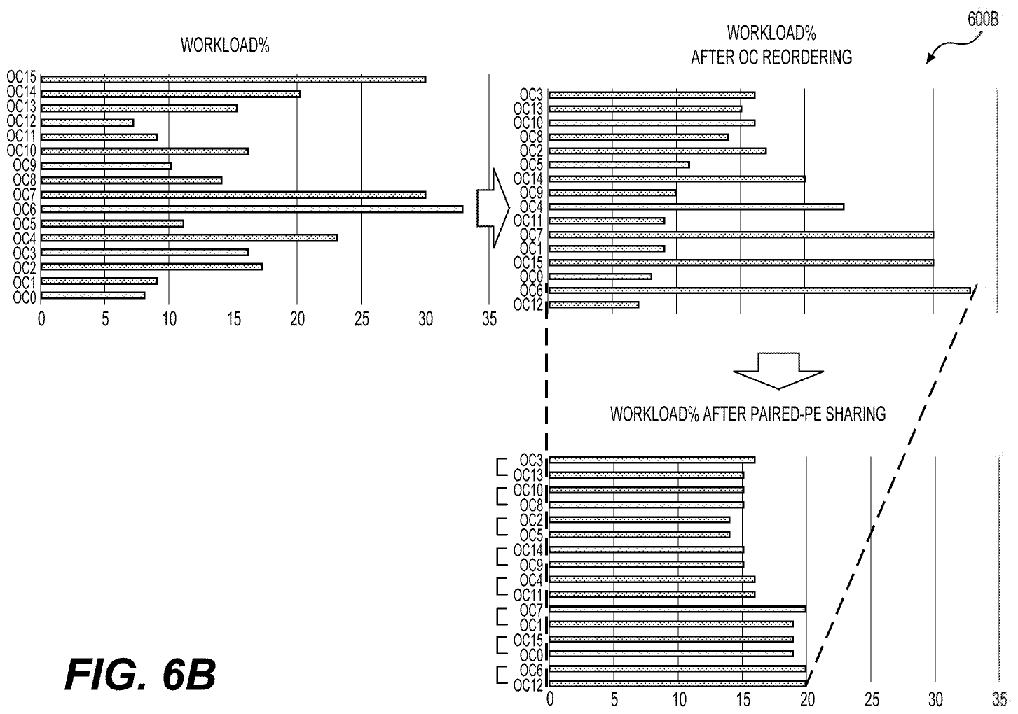

FIG. 6A shows a workload balancing (sharing) scheme 600A according to an embodiment of the disclosure. In the workload sharing scheme 600A, unbalanced workloads of two OCs can be shared by a PE pair. The PE pair includes two PEs that operate as a workload sharing group. A controller in a DLA can be configured to identify the unbalanced workloads of the two OCs and schedule (or map) the workloads (weights) to members of the PE pair in a balanced way. For example, if one of the two PEs in a PE pair has completed the computation or stalled for assigned activation inputs (and weights), it can share the remaining workload of the other PE in the same sharing group.

As shown in FIG. 6A, there are 16 active OCs (OC0-OC1) under processing. A workload of each OC is represented as a percentage of non-zero weights among all weights corresponding to a set of active ICs (not shown) for computing output activations of the respective OC. (Such a percentage can be referred to as a weight sparsity of the weights under discussion.) As can be seen, the workloads of OC0 to OC15 vary. For example, the OC15 has a workload of 30%, while the OC14 has a workload of 20%. The OC7 has a workload of 30%, while the OC6 has a workload of 33%. The workload of each OC can be assigned to a PE. In other words, the weights of the active ICs of each OC are allocated to the respective PE for processing.

To reduce the workload imbalance, in an embodiment, the workloads of every two neighboring OCs are shared by a PE pair. For example, the workloads of OC15 and OC14, 30% and 20%, respectively, are averaged, and each PE of the respective PE pair is assigned a workload of 25%. The maximum workload (OC6) is reduced from 33% (before the paired-PE sharing) to 30% (after the paired-PE sharing).

In some examples, the paired-PE sharing can be applied to workloads of non-adjacent OC channels, under control of a controller. For example, the workloads of OC0 and OC2 can be shared by a PE pair, or the workloads of OC0 and OC15 can be shared by a PE pair, depending on the configuration of the controller.

In some examples, workload sharing can take place among more than two PEs. For example, every N OCs can share a group of N PEs (a PE group) for workload balancing, and N can be an integer larger than 2. By suitably configure a controller, the workloads can be scheduled and mapped evenly among the N PEs.

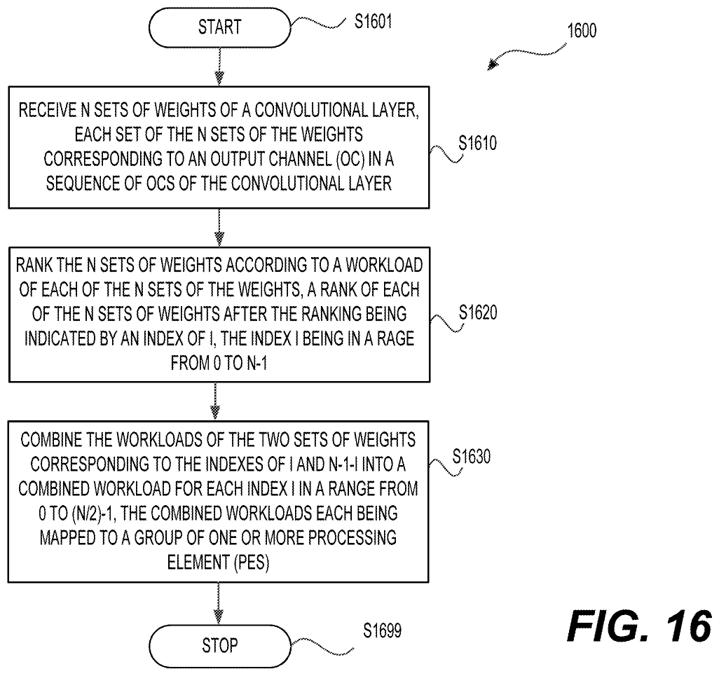

FIG. 6B shows another workload balancing (sharing) scheme 600B according to an embodiment of the disclosure. The same workloads of the same OCs (OC0-0C15) as in FIG. 16A are shown at the upper-left corner of FIG. 6B. The first step is to reorder the OC0-0C15 according to the workloads (weights) of each OC. The OC0-OC15, originally in order of 0, 1, 2, . . . 15, are now rearranged into a new order as shown at the upper-right corner of FIG. 6B.

The reordering step in FIG. 6B changes the mapping relationship between the OC workloads and the PE pairs compared with the FIG. 6A example. During the reordering operation, the number of non-zero weights (workloads) of each OC is identified. Based on the amounts of the workloads, two workloads of the originally non-neighboring two OCs can be grouped and mapped to a PE pair for processing. For example, the highest workload of OC6 (33%) is combined with the lowest workload of OC12 (7%), the second highest workload of OC15 (30%) is combined with the second lowest workload of OC0 (8%), and so on for the remaining OCs.

The next step is to share or allocate workloads (non-zero weights) between paired PEs. As shown at the lower-right corner of FIG. 6B, the workloads are evenly shared by a pair of PEs. For example, for OC6 (workload 33%) and OC12 (workload 7%), which are combined and shared by a PE pair, a workload of 20% is allocated to each of the pair of PEs. Compared with the FIG. 6A example, the OC-reordering and paired-PE-sharing method effectively reduce the maximum workload of 33% after paired PE sharing in FIG. 6A to the maximum workload of 20% in FIG. 6B.

The OC reordering and paired-PE sharing scheme, as disclosed herein, can be implemented differently in different embodiments. In an example, the reordering-and-sharing scheme can be implemented by using a controller in a DLA. For example, the controller in the DLA can rank N sets of OC weights in a buffer according to a sparsity of each set of the OC weights. For example, each set of the OC weights corresponds to an active OC in a sequence of OCs of a convolutional layer and has an index of i after the ranking. The index i can be in a rage from 0 to N−1. The controller can then balance workloads of every two sets of OC weights in the buffer having indexes of i and N−1−i for i in a range from 0 to (N/2)−1.

In an example, a compiler can be employed to rank M sets of OC weights according to a sparsity of each set of the OC weights. Each set of the OC weights corresponding to an OC in a sequence of OCs of a convolutional layer. The compiler can then reorder the OCs corresponding to the M sets of the OC weights according to respective ranks of the M sets of the OC weights (for example, in a similar way shown in FIG. 6B). Thereafter, the OC weights can be loaded to a DLA based on the modified OC order. The DLA can implement the paired-PE sharing scheme and suitably balance two workloads of neighboring OCs between paired PEs.

It is noted that the ranking method is merely an example for identifying the amounts of OC workloads so that pairs of workloads can be formed suitably. In place of the ranking, any other methods can be used to identify two OC workloads such that, among a group of OCs, the highest workload can be combined with the lowest workload, the second highest workload can be combined with the second lowest workload, and so on.

The OC reordering scheme (in combination with paired-PE sharing) disclosed herein may be performed over all OCs or a subset of OCs in various embodiments. In an example, a controller in a DLA may consider workloads of all active OCs to perform an OC reordering of all active OCs. In another example, a controller in a DLA may consider workloads of a subset of all active OCs to perform the OC reordering of the subset of active OCs. For example, the active OCs can be partitioned into groups. Then, OC reordering can be performed on the basis of active OC groups.

In an example, a compiler may reorder all OCs in a layer together. In another example, a compiler may consider a buffer size of a DLA (the number of active OCs). For example, if the maximum number of active OCs the DLA can accommodate is K, the compiler can perform OC reordering over K number or less than K number of OCs.

In addition, during OC reordering, a complier may consider a number of active ICs restricted by a buffer size of a DLA. Corresponding to a number of active ICs to be processed, the compiler may reorder only weights of the active ICs. Corresponding to different groups of active ICs in a layer, the OC reordering can be performed independently over weights corresponding to each group of active ICs. Alternatively, a compiler can perform OC reordering without considering the factor of active ICs.

While workloads corresponding to two OCs (adjacent or non-adjacent) are assumed to be performed by a pair of PEs in some examples described herein, workloads of a group of OCs (2, 3, or more) identified by various ways (being adjacent OCs, ranking, and/or reordering, or the like) can readily be mapped, scheduled, or assigned to any number of PEs in place of the pair of PEs. For example, workloads of two identified OCs can be combined and assigned to one PE or 3 PEs for processing. No matter what number of PEs in a group of PEs are allocated for processing a combined workload, the load balancing performance can be achieved among different groups of PEs by suitably employing the load balancing techniques disclosed herein.

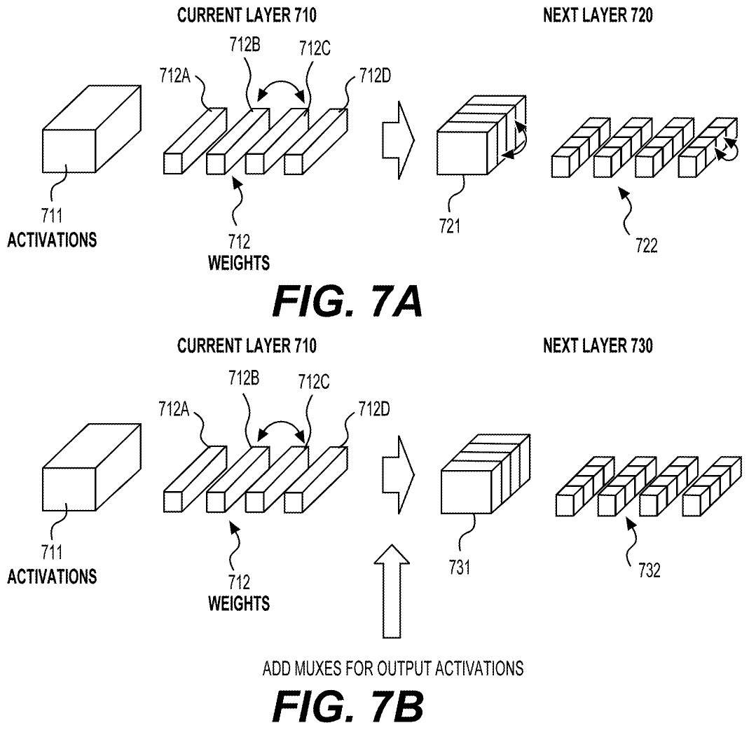

FIGS. 7A-7B show a technique of reordering back OCs when the OC reordering and paired-PE sharing scheme are employed. In FIG. 7A, in a current convolutional layer, weights 712 (including 4 filters 71 2A-712D) are reordered due to the employment of the OC reordering scheme. As shown, the filter 712A and the filter 712B are swapped in position. Using activations 711 as an input, output activations 721 can be generated where the second and third feature maps are swapped due to the OC reordering. To match with the resulting output activations 721, as an input to a next layer 720, the weights 722 of the next layer 720 may have to reordered. For example, two weight kernels in a filter may have to be swapped as shown.

As can be seen, reordering an OC order in a current layer changes an IC order of a next layer. The IC order of the next layer can be reordered due to the OC order of the current layer. However, a current layer may be connected to multiple next layers. It can be complex to identify all next layers and swap weights (weight kernels) according to the modified IC order.

FIG. 7B shows a scheme where OCs are reordered back to their original order when the OC reordering scheme is employed. As shown, in an example, after the output activations 721 are generated, a circuit (e.g., multiplexers (Muxes)) can be used to reorder the output activations of the respective OC back to the original order before the OC reordering scheme is applied. In this way, input activations 731 of a next layer 730 maintain their original order. The reordering operations to the weights 722 in FIG. 7A can be avoided for weights 732 of the next layer 730.

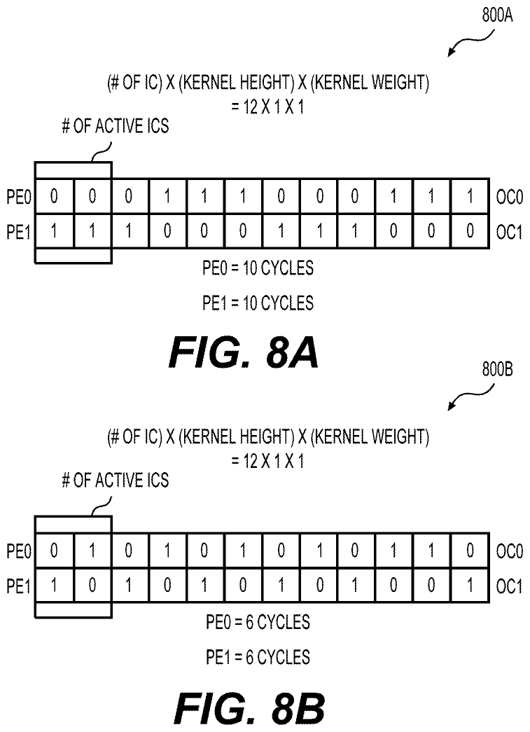

FIG. 8A shows a pruning scheme 800A according to an embodiment of the disclosure. The pruning scheme, when applied, can reduce inter-PE workload imbalance caused by zero skipping. The pruning scheme makes an amount of non-zero weights to be equal for active OCs so that workload imbalance among active OCs can be improved. Thus, the pruning scheme 800A can be referred to as an active OC-aware balanced pruning.

In the FIG. 8A example, a convolutional layer includes 12 ICs each corresponding to a weight kernel of a size of 1×1 weights. Accordingly, each OC in the convolutional layer can correspond to 12 weights to be processed. A number of active OCs is configured to be 2. Active OCs (OC0 and OC1) can be processed in parallel by PE0 and PE1, respectively, in a DLA.

A pruning process can be performed with consideration of the number of active OCs determined by a configuration of the DLA. During the pruning process, the weights of OC0 and OC1 can be pruned to have an equal number of non-zeros (or zeros). In FIG. 8A, the weights for active OC0 and OC1 are both pruned to include 6 non-zero weights. Thus, PE0 and PE1 have a balanced workload in terms of the non-zero weights.

In FIG. 8A, the PE0 and PE1 can each complete an equal workload of 6 non-zero weights in 6 cycles if PE0 and PE1 operate independently. However, if considering a number of active ICs (shared by PE0 and PE1) that the DLA can support, the total cycles would be larger than 6 cycles. As shown, when two active ICs are supported, during the first two cycles, PE1 could perform two MAC operations while PE0 would be idle for two cycles. As the ICs (weights of the ICs) are loaded to the DLA pair by pair, the total compute time would be 10 cycles (longer than 6 cycles) for both PE0 and PE1 to complete the workloads at a worst case.

FIG. 8B shows another pruning scheme 800B according to an embodiment of the disclosure. The pruning scheme 800B can reduce the above OC workload imbalance within active ICs. Thus, the pruning scheme 800B can be referred to as an active OC and IC-aware balanced pruning.

Specifically, during a pruning process, non-zero weights corresponding to active ICs are made to be equal for active OCs. Various methods can be used in various embodiments to achieve this effect. In an example, weights of each OC are partitioned into groups. Each group includes a number of weights corresponding to the number of active ICs a DLA can support. Then, the weights in each group can be ranked according to a magnitude of each weight. Thereafter, the same number of weights of the smallest ranks can be pruned for each group. In this way, the number of the weights of different OCs but corresponding to a same set of ICs will be the same, resulting in a balanced workload for different active OCs and the same active ICs. The above rank based pruning process can be performed over active OCs that will be processed in parallel on the DLA.

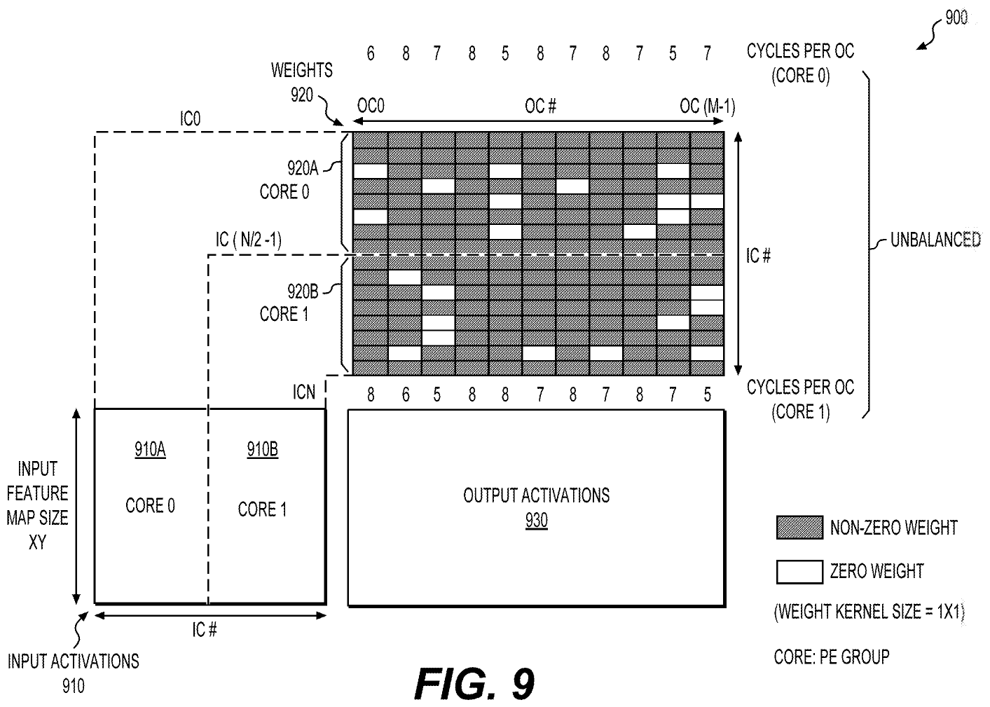

FIG. 9 shows a workload allocation method 900, referred to as symmetric multi-core IC slicing. In the method 900, workloads are partitioned and assigned to multiple processing cores by evenly partition the number of ICs. A processing core can be one PE or a PE group (multiple PEs).

In the FIG. 9 example, two processing cores are configured: Core 0 and Core 1. Input activations 910 can come from N number of ICs from IC0 to IC(N−1). Each input channel has an input feature map of a size of X by Y. The input activations 910 are partitioned into two portions: a first portion 910A corresponding to IC0-IC(N/2−1) and the second portion 910B corresponding to IC(N/2)-IC(N−1). The two portions are processed by Core 0 and Core 1, respectively.

Output activations 930 correspond to M number of OCs from OC0 to OC(M−1). Weights 920 (including zero and non-zero weights) for generating the output activations 930 of the M OCs are also partitioned evenly into two portions 920A and 920B and assigned to Core 0 and Core 1, respectively. PSUMs generated from Core 0 and Core 1 corresponding to a same output activation can be added and stored as part of the output activations 930.

Run times in cycles for each OC are listed for Core 0 and Core 1 separately. Assuming each weight kernel has a size of 1×1 weight, non-zero weight and zero weight are represented by shaded and unshaded rectangles in FIG. 9, respectively. The run times are determined by the number of zero weights corresponding to the respective OC and core. As can be seen, when the weights of an OC are evenly partitioned, unevenly distributed zero weights can cause an unbalanced workload between the pair of PEs in the two processing cores that are configured for computing PSUMs for a same OC.

For example, for OC(M−1), 7 non-zero weights of IC0-IC(N/2−1) are assigned to a PE0 in Core 0, while 5 non-zero weights of IC(N/2)-ICN are assigned to a PE1 in Core 1. Two PEs independently compute PSUMs of output activations of OC(M−1). PE0 operates for 7 cycles while PE1 operates for 5 cycles and idles for 2 cycles during the process of computing the output activations for OC(M−1). As shown, such imbalance exists for all OC channels except OC3.

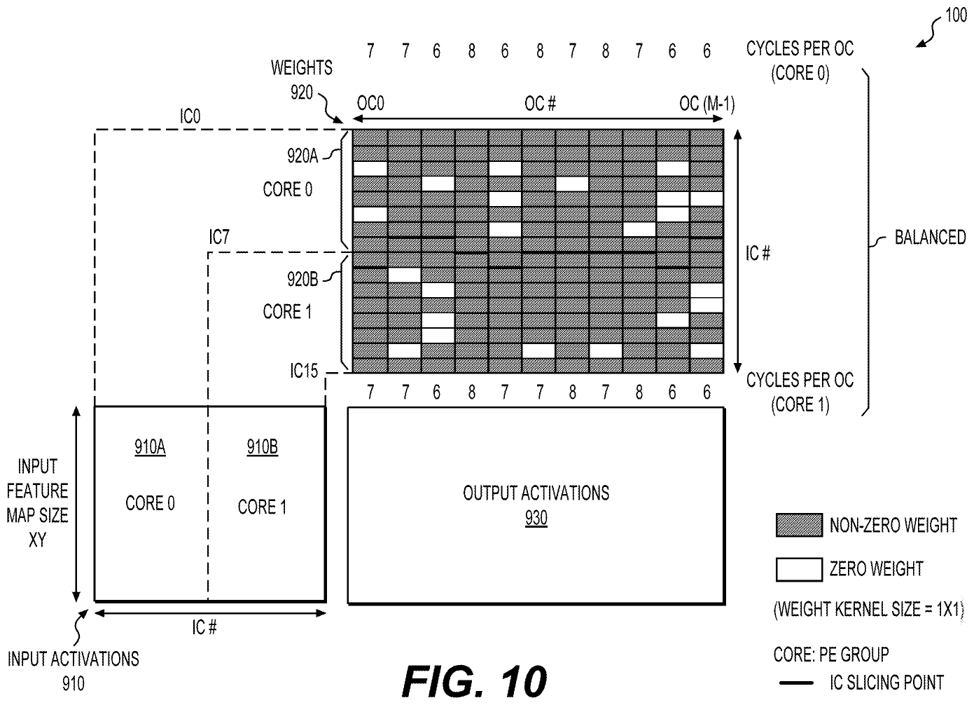

FIG. 10 shows another workload allocation method 1000, referred to as dynamic asymmetric multi-core IC slicing. In the method 1000, a workload of an OC are partitioned and assigned to multiple processing cores in a balanced manner. For example, ICs (weight kernels of the ICs) are partitioned in a balanced way such that the numbers of non-zero weights assigned to each of the multiple processing cores are the same or almost the same. In this way, PEs configured for computing for a same OC but distributed in multiple cores can have similar run times and utilization rates (e.g., number of MAC operations).

As shown in the FIG. 10 example, the same input activations 910 and weights 920 are provided for computing the output activations 930. For each OC, the weights 920 correspond to 16 ICs (IC0-IC15). Workloads of each OC are partitioned differently but in a balanced way (indicated by an IC slicing point) for processing by the same pair of Cores: Core 0 and Core 1.

For example, for OC(M−1), indicated by the respective IC slicing point, 7 ICs (weights of ICs) from IC0 to IC6, which includes 6 non-zero weights, are assigned to Core 0. Nine ICs (weights of ICs) from IC7 to IC15, which also includes 6 non-zero weights, are assigned to Core 1. In this way, Core 0 and Core 1 can have a balanced workload for computing PSUMs for the same OC.

The dynamic asymmetric multi-core IC slicing scheme can be implemented with hardware (e.g., a controller in a DLA), software (e.g., a compiler), or a combination thereof in various embodiments. An example of a compiling process implementing the dynamic asymmetric multi-core IC slicing is described below.

In the example, two processing cores (Core 0 and Core 1) are used for processing a convolutional layer in a neural network. The convolutional layer can include N number of ICs from IC0 to IC(N−1).

During the compiling process, a compiler can divide (or identify) weight kernels into weight groups each corresponding to an OC. Each weight group of weight kernels can have a group index of i. For example, i can be in a range from 0 to M−1. For each weight group i, the compiler can determine a number of the ICs (denoted by Pi) assigned to Core 0 such that a runtime of convolution operation of Core 0 on IC0-IC(Pi−1) can be the same as or almost the same as that of convolution operation of Core 1 on IC(Pi)-IC(N−1). The following constraints are applied on determining Pi: the runtime of the convolution operation of Core 0 on IC0-IC(Pi−1) is balanced with the runtime of the convolution operation of Core 1 on IC(Pi)-IC(N−1) as close as possible. Pi determines the slicing point of the respective OC (e.g., OCi).

In a next step, the parameters Pi for each OC (or weight group i) can be embedded in commands sent to the convolution cores, Core 0 and Core 1. The cores can accordingly be configured and get ready to receive the respective weight kernels and input activations.

In a final step, Core 0 can accordingly perform computation based on the weight kernels of IC0-IC(Pi−1), while Core 1 can accordingly perform computation of PSUMs based on the weight kernels of IC(Pi)-IC(N−1).

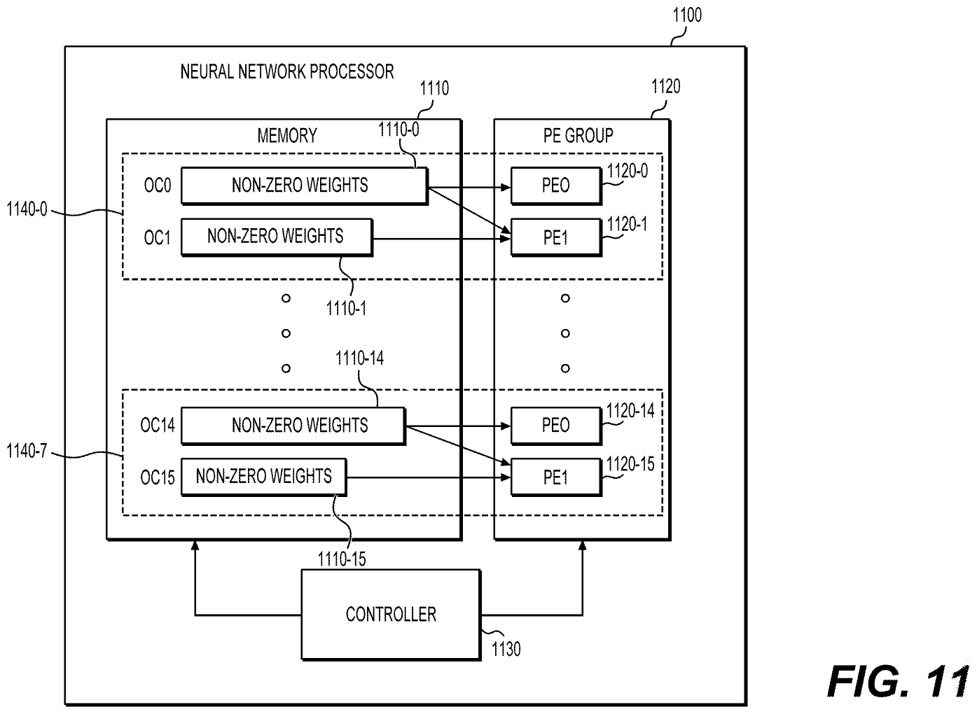

FIG. 11 shows a neural network processor 1100 according to an embodiment of the disclosure. The neural network processor 1100 implements the paired-PE-sharing workload balancing scheme. The neural network processor 1100 can be a CPU, a GPU, FPGA, an ASIC, a DLA, an artificial accelerator (AI) accelerator, and the like. The neural network processor 1100 can include a memory 1110, a PE group (or PE array) 1120, and a controller 1130. Those elements are coupled together as shown in FIG. 11.

The memory 1110 can be configured to store parameters of a neural network, such as weights, input activations, output activations (PSUMs), and the like. Those parameters may be read from a memory outside of the neural network processor (e.g., off-chip memory). In FIG. 11, the memory 1110 is shown to store 16 groups of non-zero weights (from group 1110-0 to group 1110-15) corresponding to 16 active OCs from OC0 to 0C15. The non-zero weights can correspond to a set of active ICs. In other examples, to-be-processed weights can be stored in a compressed (encoded) form and decoded from the compressed form before provided to the PE group 1120. Suitable control logic can be provided for implementing the decoding function.

The PE Group 1120 can include an array of PEs. Each PE can include suitable circuits for performing MAC operations, such as buffers (for holding weights, input activations, or PSUMs), multipliers, accumulators, and control logic. Depending on configurations, the PEs may have different compute capabilities. In an example, the PEs can each be configured to compute and accumulate PSUMs of one output activation based on weights corresponding to one OC. In an example, the PEs can each be configured to compute and accumulate PSUMs for multiple output activations in one OC based on weights corresponding to the OC.

In FIG. 11, the PE group 1120 is shown to include 16 PEs from PE0 to PE 15 (labeled as PE 1120-0 to PE 1120-15). Each of the 16 PEs can be configured to compute PSUMs of one of the 16 OCs (from OC0 to 0C15), respectively, using the respective group of non-zero weights of the respective OC.

The controller 1130 can be configured to perform workload balancing based on the paired-PE-sharing scheme disclosed herein. For example, controlled by the controller 1130, the weight groups (group 1110-0 to group 1110-15) and the PEs (PE 1120-0 to PE 1120-15) can operate as eight workload sharing groups from group 1140-0 to group 1140-15. Workloads within each workload sharing group can be balanced between the pair of PEs within each group.

For example, for the workload sharing group 1140-0, the controller 1130 can determine the workload of each OC (OC0 or OC1) based on a number of respective non-zero weights and detect workload imbalance between the pair of OCs (OC0 and OC1). As shown, the workload of OC0 is higher than the workload of OC1, and a workload imbalance exists between OC0 and OC1. The controller 1130 can accordingly make a decision to allocate a certain number of the non-zero weights of OC0 from PE0 to PE1 to balance the unbalanced workload.

PSUMs corresponding to a same output activation of OC0 but generated by PE0 and PE1 can be accumulated in various ways. For example, a first intermediate PSUM generated by PE0 can be stored to the memory 1110. A second intermediate PSUM generated by PE1 can later be accumulated with the first intermediate PSUM. Or, the first intermediate PSUM from PE0 can be read and stored in a buffer in PE1. Results of MAC operations at PE1 can be accumulated to the first intermediate PSUM.

In the FIG. 11 example, each pair of weight groups in a workload sharing group from 1140-0 to 1140-7 are adjacent with each other (the corresponding OCs are adjacent with each other according to the order of the OCs). However, in other examples, the pair of weight groups forming a workload sharing group can be not adjacent to each other (in terms of the indexes of the corresponding OCs).

In the FIG. 11 example, each workload sharing group from 1140-0 to 1140-7 includes two weight groups processed by a pair of PEs. However, in other examples, a workload sharing group may include N weight groups processed by N PEs. The number of N can be 3, 4, 8, or more. A controller can be suitable configured to assign the non-zero weights from the respective weight groups to the respective PEs such that the workload can be balanced among the N PEs.

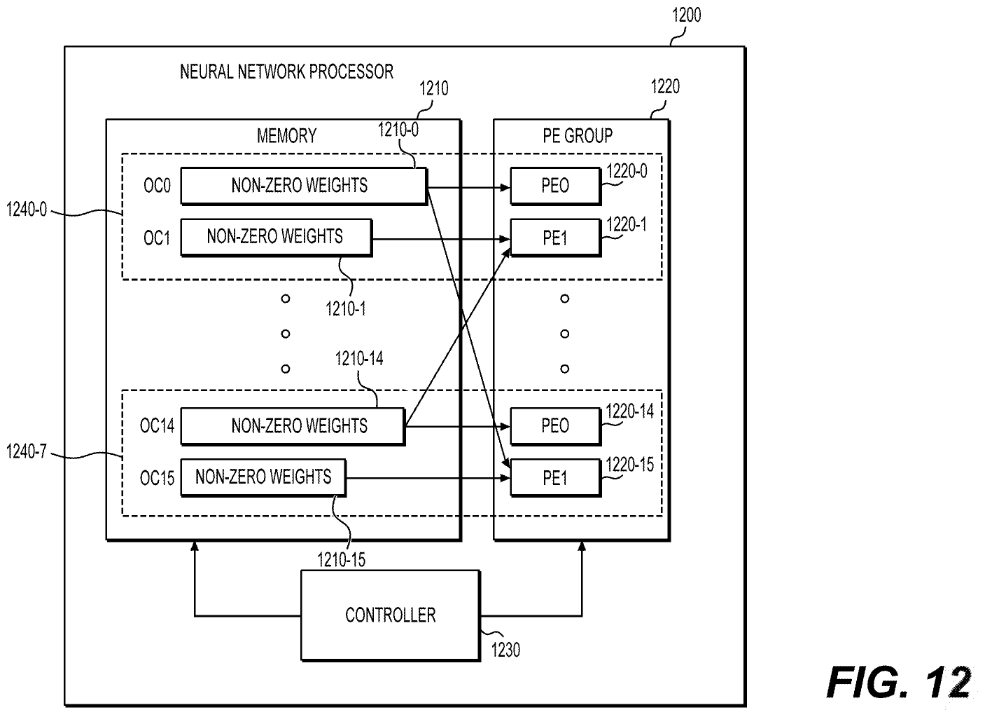

FIG. 12 shows another neural network processor 1200 according to an embodiment of the disclosure. The neural network processor 1200 implements the OC-reordering and paired-PE-sharing workload balancing scheme. The neural network processor 1200 can be a CPU, a GPU, FPGA, an ASIC, a DLA, an artificial accelerator (AI) accelerator, and the like. The neural network processor 1200 can include a memory 1210, a PE group (or PE array) 1220, and a controller 1230. Those elements are coupled together as shown in FIG. 12.

The memory 1210 can be configured to store parameters of a neural network. In FIG. 12, the memory 1210 is shown to store 16 groups of non-zero weights (from group 1210-0 to group 1210-15) corresponding to 16 active OCs from OC0 to OC15. The non-zero weights can correspond to a set of active ICs.

The PE Group 1220 can include an array of PEs. Each PE can be configured to compute and accumulate PSUMs of one or multiple output activations based on weights corresponding to one OC. In FIG. 12, the PE group 1220 is shown to include 16 PEs from PE0 to PE 15 (labeled as PE 1220-0 to PE 1220-15). Each of the 16 PEs can be configured to compute PSUMs of one of the 16 OCs (from OC0 to 0C15), respectively, using the respective group of non-zero weights of the respective OC.

The controller 1230 can be configured to perform workload balancing based on the OC-reordering and paired-PE-sharing scheme disclosed herein. For example, the controller can determine (or identify) workloads of each weight group (or OC) and accordingly organize the weight groups into workload sharing groups to minimize a processing time for completing workloads of all active OCs given the weights of a set of active ICs.

For example, the controller 1230 can identify a first OC with the highest workload (largest number of non-zero weights) and a second OC with the lowest workload and include the first and second OC into a same workload sharing group. The controller 1230 can identify a third OC with the second highest workload (largest number of non-zero weights) and a fourth OC with the second lowest workload and include the third and fourth OC into a same workload sharing group. In a similar way, the other OCs can be paired up to form respective workload sharing groups. In some examples, ranking of the workloads can be used to identify the members of a particular workload sharing group.

In the FIG. 12 example, the weight groups 1210-0 and 1210-15 are determined as a workload sharing group by the controller 1230, and a portion of the weights of OC0 are allocated to PE 1220-15 for processing. The weight groups 1210-1 and 1210-14 are organized as a workload sharing group by the controller 1230, and a portion of the weights of OC14 are allocated to PE 1220-1 for processing.

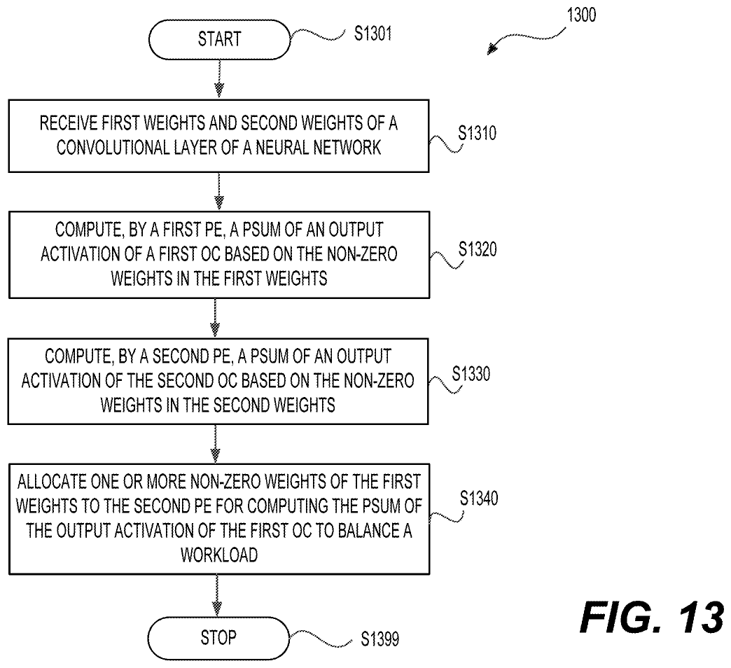

FIG. 13 shows a process 1300 of balancing workloads among PEs in a neural network processor according to an embodiment of the disclosure. The process 1300 can start from S1301 and proceed to S1310.

At S1310, first weights and second weights of a convolutional layer of a neural network can be received at a memory in the neural network processor. The first weights can be associated with a first OC of the convolutional layer, while the second weights can be associated with a second OC of the convolutional layer. The first weights and the second weights can correspond to a same set of input channels (ICs) of the convolutional layer. In some examples, the first weights and the second weights are received and stored in the memory in a compressed form. Non-zero weights can be decoded properly at the neural network processor. In addition, a number of non-zero weights or zero weights of the first weights and the second weights can be properly determined.

At S1320, a PSUM of an output activation of the first OC can be computed by a first PE in the neural network processor based on the non-zero weights in the first weights.

At S1330, a PSUM of an output activation of the second OC can be computed by a second PE in the neural network processor based on the non-zero weights in the second weights. Zero-skipping techniques are used at the neural network processor. Non-zero weights can be properly provided to PEs in the neural network processor for processing. Zero weights can be skipped from being processed by the PEs.

At S1340, one or more non-zero weights of the first weights can be allocated by a controller in the neural network processor to the second PE for computing the PSUM of the output activation of the first OC to balance a workload between the first PE and the second PE when a first number of the non-zero weights in the first weights is larger than a second number of the non-zero weights in the second weights.

For example, the controller can determine whether a workload imbalance exists between the first PE and the second PE based on the first number of the non-zero weights in the first weights and the second number of the non-zero weights in the second weights. The workload balancing operation at S1340 can accordingly be performed when the workload imbalance exists.

In some examples, a workload of every two sets of weights in the memory corresponding to every two neighboring active OCs in a sequence of OCs of the convolutional layer is balanced by the controller between a pair of PEs. In some examples, the first OC and the second OC are not adjacent to each other in a sequence of OCs of the convolutional layer.

In various examples, the OC reordering can be performed at the neural network processor or at a compiler before the weights are read into the neural network processor. By OC reordering, for example, the maximum OC workload and the minimum OC workload can be combined and balanced between two PEs, and the second maximum OC workload and the second minimum OC workload can be combined and balanced between two PEs.

In some examples, the OC workload can be indicated by an amount of non-zero weights corresponding to the respective OC. In some examples, the OC workload can be indicated by a sparsity of weights corresponding to the OC. A sparsity can be a ratio of a number of non-zero weights to a number of all the weights corresponding to the OC.

In some examples, the workload balancing of different OCs is performed among more than two PEs (e.g., 3, 4, 8, or the like). The process 1300 can proceed to S1399 and terminate at S1399.

It is noted that, although steps of a process may be described sequentially, the steps may be performed in a different order than described or may be performed in parallel in various embodiments. Also, one or more steps may not be performed in some embodiments. For example, the operations of S1320-S1340 can be performed in any order or in parallel.

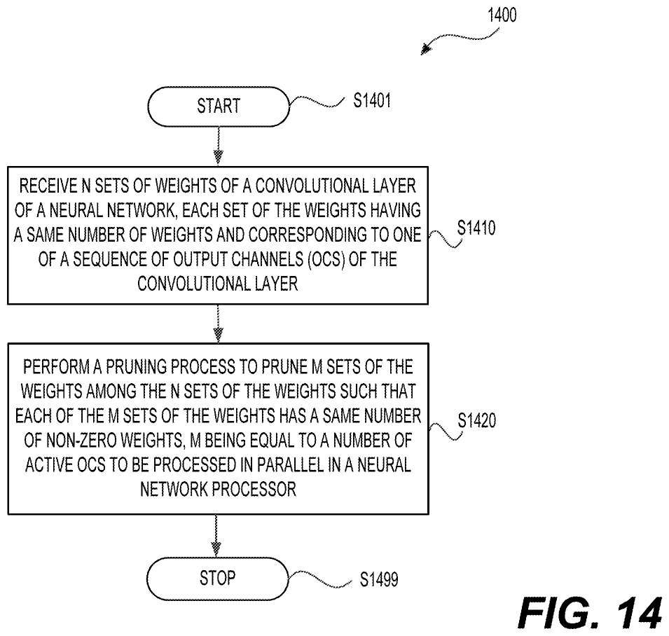

FIG. 14 shows a process 1400 of pruning weights in a convolutional layer of a neural network according to an embodiment of the disclosure. The process 1400 can be performed by a compiler or a neural network processor in various embodiments. As a result of the process 1400, workload corresponding to different OCs can be balanced when the convolutional layer is processed at a neural network processor. The process 1400 can start from S1401, and proceed to S1410.

At 51410, N sets of weights of a convolutional layer of a neural network can be received. Each set of the weights can have a same number of weights and corresponds to one of a sequence of OCs of the convolutional layer.

At S1420, a pruning process can be performed to prune M sets of the weights among the N sets of the weights such that each of the M sets of the weights has a same number of non-zero weights. M can be smaller than or equal to N. For example, M can be equal to a number of active OCs to be processed in parallel in a network processor.

In an example of the pruning process, L sets of the weights can be identified among the N sets of the weights. Then, K weights can be identified from each of the L sets of the weights. L can be in a range of 2 to N. L can be equal to, larger than, or smaller than M. The K weights of each of the L sets of the weights can correspond to a same set of active input channels (ICs) to be processed in the neural network processor. The K weights of each of the L sets of the weights can be pruned such that the K weights of each of the L sets of the weights have a same number of non-zero weights.

In an example, L0 sets of the weights can be identified among the N sets of the weights. Then, the weights in each of the L0 sets of the weights can be partitioned into groups of weights. In each of the L0 sets of the weights, the groups may have indexes from 0 to i. L0 can be in a range of 2 to N. L0 can be equal to, larger than, or smaller than M. The groups of weights with the same index in the L sets of the weights correspond to a same set of active ICs to be processed in the neural network processor.

The weights in each group of weights in the L0 sets of weights can be ranked according to, for example, weight magnitudes. The weights from each group of weights in the L sets of weights can be pruned according to the ranks of the respective weights. For example, a same number of weights can be pruned for the groups of weights with the same index in each of the L sets of weights. For the groups with different indexes, a same number or different numbers of weights can be pruned in different examples.

The process 1400 can proceed to S1499 and terminate at S1499.

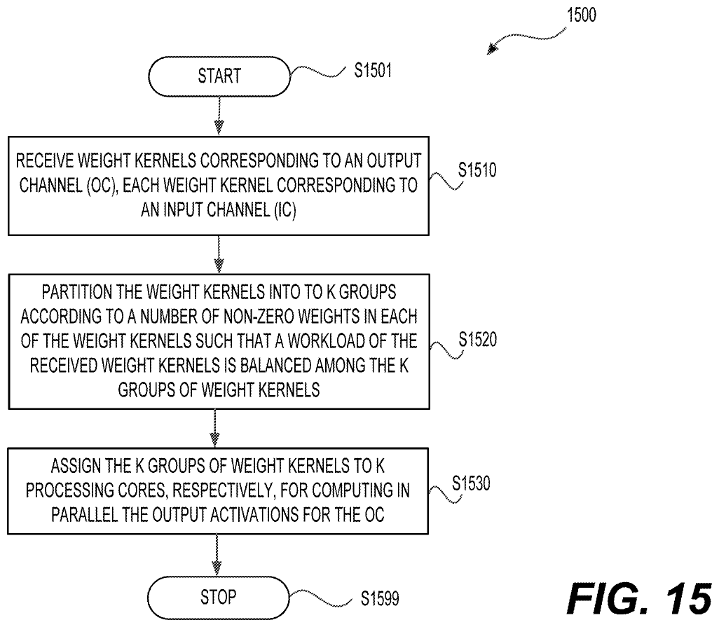

FIG. 15 shows a process 1500 of IC-based workload partitioning and balancing according to an embodiment of the disclosure. The process 1500 can be performed at by a compiler or a neural network processor. The process 1500 can start from S1501 and proceed to S1510.

At S1510, weight kernels corresponding to an OC in a convolutional layer of a neural network can be received. Each weight kernel can correspond to an IC in the convolutional layer of the neural network.

At S1520, the weight kernels can be partitioned into K groups according to a number of non-zero weights in each of the weight kernels such that a workload of the received weight kernels is balanced among the K groups of weight kernels. K can be a number of processing cores in the neural network processor used for computing output activations for the OC in the convolutional layer of the neural network.

At S1530, the K groups of weight kernels can be assigned (or allocated) to the K processing cores, respectively, for computing in parallel the output activations for the OC in the convolutional layer of the neural network.

In an example, the convolutional layer of the neural network can include N number of OCs, and weight kernels of each of the N number of OCs are petitioned into K groups according to an amount of non-zero weights in the respective weight kernels for workload balancing among the respective K groups.

The process 1500 can proceed to S1599 and terminate at S1599.

FIG. 16 shows a process 1600 of balancing workload among different PEs or PE groups according to an embodiment of the disclosure. The process 1600 can be performed by a neural network processor or a compiler. The process 1600 can start from S1601 and proceed to S1610.

At S1610, N sets of weights of a convolutional layer of a neural network can be received at the neural network processor or the compiler. N can be an integer greater than 2 in some examples. Each set of the N sets of the weights correspond to an OC in a sequence of OCs of the convolutional layer. When being processed at the neural network processor, the N sets of the weights can correspond to a set of active OCs in some examples.

At S1620, the N sets of weights can be ranked according to a workload (or sparsity) of each of the N sets of the weights. The workload or sparsity of each of the N sets of the weights can be indicated by an amount of non-zero or zero weights in each of the N sets of the weights in some examples. The workload and sparsity of each of the N sets of the weights can be represented by a ratio of an amount of zero or non-zero weights in each of the N sets of the weights to a total number of weights in each of the N sets of the weights in another example. A rank of each of the N sets of weights after the ranking can be indicated by an index of i, the index i being in a rage from 0 to N−1.

At S1630, the workloads of the two sets of weights corresponding to the indexes of i and N−1-i can be combined (or grouped) into a combined workload for at least one index i in a range from 0 to (N/2)−1. The N/2 number of combined workloads can each be mapped (assigned or scheduled) to a group of PEs. The group of PEs can include one or more PEs. In this way, the workloads of the N sets of weights can be balanced among different groups of PEs.

For example, the workload of the set of the weights with a maximum amount of non-zero weights and the workload of the set of the weights with a minimum amount of non-zero weights are combined and mapped to the respective group of one or more PEs. The workload of the set of the weights with a second maximum amount of non-zero weights and the workload of the set of the weights with a second minimum amount of non-zero weights are combined and mapped to the respective group of one or more PEs.

In a further example, more than two sets of the N sets of weights can be combined. For example, the workloads of the sets of weights of the indexes 0, 1, (N/2)−2, and (N/2)−1 (two sets with maximum amount of weights and two sets with minimum amount of weights) can be combined and mapped to a group of PEs. Similarly, the workloads of the remaining set of weights can be grouped in a similar way.

In an example, the OCs corresponding to the N sets of the weights may be reordered according to the respective ranks of the N sets of the weights. For example, the OCs of the two sets of weights corresponding to the indexes of i and N−1−i can be reordered or arranged to be adjacent to each other, for at least one index i in the range from 0 to (N/2)−1. The two sets of weights corresponding to these two adjacent OCs can be assigned, scheduled, or mapped to a group of one or more PEs. The process 1600 can proceed to S1699 and terminate at S1699.

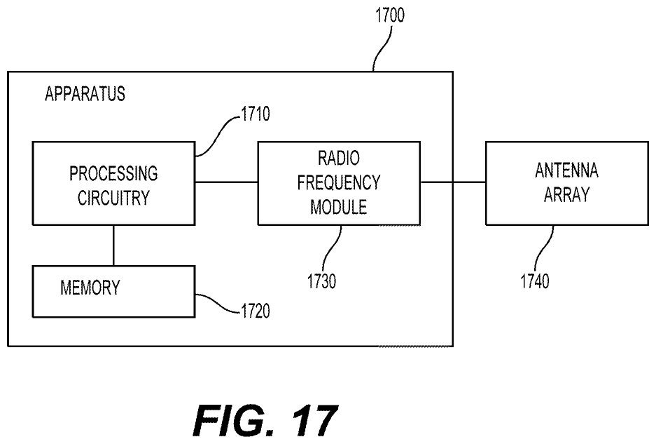

FIG. 17 shows an exemplary apparatus 1700 according to embodiments of the disclosure. The apparatus 1700 can be configured to perform various functions in accordance with one or more embodiments or examples described herein. Thus, the apparatus 1700 can provide means for implementation of mechanisms, techniques, processes, functions, components, systems described herein. For example, the apparatus 1700 can be used to implement functions of a compiler in various embodiments and examples described herein. The apparatus 1700 can include a general-purpose processor or specially designed circuits to implement various functions, components, or processes described herein in various embodiments. The apparatus 1700 can include processing circuitry 1710, and a memory 1720. The apparatus can optionally include a radio frequency (RF) module 1730 and an antenna array 1740.

In various examples, the processing circuitry 1710 can include circuitry configured to perform the functions and processes described herein in combination with software or without software. In various examples, the processing circuitry 1710 can be a digital signal processor (DSP), an application-specific integrated circuit (ASIC), programmable logic devices (PLDs), field-programmable gate arrays (FPGAs), digitally enhanced circuits, or comparable device or a combination thereof.

In some other examples, the processing circuitry 1710 can be a central processing unit (CPU) configured to execute program instructions to perform various functions and processes described herein. Accordingly, the memory 1720 can be configured to store program instructions. The processing circuitry 1710, when executing the program instructions, can perform the functions and processes. The memory 1720 can further store other programs or data, such as operating systems, application programs, and the like. The memory 1720 can include non-transitory storage media, such as a read-only memory (ROM), a random access memory (RAM), a flash memory, a solid-state memory, a hard disk drive, an optical disk drive, and the like.

In an embodiment, the RF module 1730 receives a processed data signal from the processing circuitry 1710 and converts the data signal to wireless signals that are then transmitted via the antenna array 1740, or vice versa. The RF module 1730 can include a digital to analog converter (DAC), an analog to digital converter (ADC), a frequency upconverter, a frequency down converter, filters and amplifiers for reception and transmission operations. The RF module 1730 can include multi-antenna circuitry for beamforming operations. For example, the multi-antenna circuitry can include an uplink spatial filter circuit and a downlink spatial filter circuit for shifting analog signal phases or scaling analog signal amplitudes. The antenna array 1740 can include one or more antenna arrays.

The apparatus 1700 can optionally include other components, such as input and output devices, additional or signal processing circuitry, and the like. Accordingly, the apparatus 1700 may be capable of performing other additional functions, such as executing application programs and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through a physical medium or distributed system, including, for example, from a server connected to the Internet.

The computer program may be accessible from a computer-readable medium providing program instructions for use by or in connection with a computer or any instruction execution system. The computer-readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random access memory (RAM), a read-only memory (ROM), a magnetic disk and an optical disk, and the like. The computer-readable non-transitory storage medium can include all types of computer-readable medium, including magnetic storage medium, optical storage medium, flash medium, and solid-state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method, comprising:
receiving, at a memory in a neural network processor, first weights and second weights of a convolutional layer of a neural network, the first weights associated with a first output channel (OC) of the convolutional layer, the second weights associated with a second OC of the convolutional layer;
computing, by a first processing element (PE) in the neural network processor, a partial sum (PSUM) of an output activation of the first OC based on non-zero weights in the first weights;
computing, by a second PE in the neural network processor, a PSUM of an output activation of the second OC based on non-zero weights in the second weights; and
allocating, by a controller in the neural network processor, one or more non-zero weights of the first weights to the second PE for computing the PSUM of the output activation of the first OC to balance a workload between the first PE and the second PE when a first number of the non-zero weights in the first weights is larger than a second number of the non-zero weights in the second weights.

2. The method of claim 1, wherein the first weights and the second weights correspond to a same set of input channels (ICs) of the convolutional layer.

3. The method of claim 1, further comprising:
determining, by the controller in the neural network processor, whether a workload imbalance exists between the first PE and the second PE based on the first number of the non-zero weights in the first weights and the second number of the non-zero weights in the second weights.

4. The method of claim 1, wherein the first weights and the second weights are in a compressed form.

5. The method of claim 1, wherein a workload of every two sets of weights in the memory corresponding to every two neighboring active OCs in a sequence of OCs of the convolutional layer is balanced by the controller in the neural network processor between a pair of PEs in the neural network processor according to an amount of non-zero weights in each set of the weights.

6. The method of claim 1, wherein the first OC and the second OC are not adjacent to each other in a sequence of OCs of the convolutional layer.

7. The method of claim 1, further comprising:
balancing a workload of P sets of weights corresponding to P number of OCs of the convolutional layer in the neural network among P number of PEs, P being a number larger than 2.

8. The method of claim 1, wherein zero-weights among the first weights and the second weights are skipped for processing during the computing by the first PE and the second PE.

9. A method, comprising:
receiving N sets of weights of a convolutional layer of a neural network, each set of the N sets of the weights corresponding to an output channel (OC) in a sequence of OCs of the convolutional layer;
ranking the N sets of weights according to a workload of each of the N sets of the weights, the workload of each of the N sets of the weights corresponding to an amount of non-zero weights in each of the N sets of the weights, a rank of each of the N sets of weights after the ranking being indicated by an index of i, the index i being in a range from 0 to N−1; and
combining the workloads of the two sets of weights corresponding to the indexes of i and N−1−i into a combined workload for at least one index i in a range from 0 to (N/2)−1, the combined workloads each being mapped to a group of one or more processing element (PEs).

10. The method of claim 9, wherein the workload of the set of the weights with a maximum amount of non-zero weights and the workload of the set of the weights with a minimum amount of non-zero weights are combined and mapped to the respective group of one or more PEs, and
the workload of the set of the weights with a second maximum amount of non-zero weights and the workload of the set of the weights with a second minimum amount of non-zero weights are combined and mapped to the respective group of one or more PEs.

11. The method of claim 9, further comprising:
reordering the OCs corresponding to the N sets of the weights according to the respective ranks of the N sets of the weights.

12. The method of claim 11, wherein the ranking or reordering is performed by a compiler or a neural network processor.

13. A method, comprising:
receiving N sets of weights of a convolutional layer of a neural network, each set of the weights having a same number of weights and corresponding to one of a sequence of output channels (OCs) of the convolutional layer; and
performing a pruning process to prune M sets of the weights among the N sets of the weights such that each of the M sets of the weights has a same number of non-zero weights, M being smaller than or equal to N, M being equal to a number of active OCs to be processed in parallel in a neural network processor.

14. The method of claim 13, wherein the pruning process is performed by a compiler or the neural network processor.

15. The method of claim 13, wherein the pruning process includes:
determining K weights from each of L sets of the weights among the N sets of the weights, L being in a range of 2 to N, the K weights of each of the L sets of the weights corresponding to a same set of active input channels (ICs) to be processed in the neural network processor; and
pruning the K weights of each of the L sets of the weights such that the K weights of each of the L sets of the weights have a same number of non-zero weights.

16. The method of claim 15, wherein L is equal to a number of active OCs to be processed in parallel in the neural network processor and is equal to or smaller than M.

17. The method of claim 13, wherein the pruning process includes:
partitioning the weights in each of L sets of the weights among the N sets of the weights into groups of weights, the groups in each of the L sets of the weights having indexes from 0 to i, L being in a range of 2 to N, the groups of weights with the same index in different sets of the L sets of the weights corresponding to a same set of active ICs to be processed in the neural network processor;
ranking the weights in each group of weights in the L sets of weights according to weight magnitudes; and
pruning the weights from each group of weights in the L sets of weights according to ranks of the respective weights, a same number of weights being pruned for the groups of weights with the same index in each of the L sets of weights.

18. A method, comprising:
receiving weight kernels corresponding to an output channel (OC) in a convolutional layer of a neural network, each weight kernel corresponding to an input channel (IC) in the convolutional layer of the neural network;
partitioning the weight kernels into K groups of weight kernels according to a number of non-zero weights in each of the weight kernels such that a workload of the received weight kernels is balanced among the K groups of weight kernels, K being a number of processing cores in a neural network processor used for computing output activations for the OC in the convolutional layer of the neural network; and
assigning the K groups of weight kernels to the K processing cores, respectively, for computing in parallel the output activations for the OC in the convolutional layer of the neural network.

19. The method of claim 18, wherein the convolutional layer of the neural network includes N number of OCs, and weight kernels of each of the N number of OCs are petitioned into K groups according to an amount of non-zero weights in the respective weight kernels for workload balancing among the respective K groups.

20. The method of claim 18, wherein the partitioning of the weight kernels and the assigning of the K groups of weight kernels are performed by a compiler or a controller in the neural network processor.
